(19) United States
(12) Patent Application Publication
(10) Pub. No.: US 2006/0109765 A1
(43) Pub. Date: May 25, 2006

(54) Method for testing assembling quality of optical storage devices and optical storage device for using such method

(75) Inventor: Yu-Yen Chen, Taipei (TW)

Correspondence Address: G. LINK CO., LTD;Suite137, PMB 174, 931 West, 75th Street, Naperville, IL, 60565, US

(73) Assignee: BEHAVIOR COMPUTER TECH CORP.

(21) Appl. No.: 10/993,842

(22) Filed: Nov. 22, 2004

(51) Int. Cl. G11B 5/09

(52) U.S. Cl. 369/53.1; 369/47.1

(57) ABSTRACT

The present invention discloses a method for testing the assembling quality of optical storage devices. The step (A) is to compute a traveling distance along the focus direction of a lens of an optical storage device, and a first travel time T1 for moving the lens from its lower limit position to its upper limit position. The step (B) is to drive an optical pickup head to emit a laser beam onto an inner track position of an optical disk and moving the lens from the lower limit position towards the upper limit position, and starting to compute the time until a focus signal occurs to obtain a second traveling time T2. The step (C) is to drive an optical pickup head to emit a laser beam onto an outer track position of an optical disk and moving the lens from the lower limit position towards the upper limit position, and starting to compute the time until a focus signal occurs to obtain a third traveling time T3. The step (D) is to use an assembling quality formula based on the first, second and third traveling time to test the assembling quality of the optical storage device.

### FIELD OF THE INVENTION

The present invention relates to a method for testing optical storage devices, more particularly to a method for testing an optical storage device to check the assembling quality for achieving its focus function.

### BACKGROUND OF THE INVENTION

In a prior-art optical disk drive, the focus loop will control the lens after it enters into the servo control, so that the laser beam can be focused precisely on the recording layer of an optical disk. However, the focus loop generally has to pay a high price such as slowing down the reading of an optical disk or worsening the duplication capability to maintain the focus of the optical disk. Although optical disk drive manufacturers use tools to adjust all assembled components, it is difficult to assure the acceptable final assembling quality after the adjustment is made due to human errors and tool precision.

In view of the shortcomings of the prior art, the inventor of the present invention thought of a way of running a program to test the assembling quality of the focus function of an optical storage device without using a tool.

### SUMMARY OF THE INVENTION

Therefore, the primary objective of the present invention is to provide a method for testing the assembling quality of optical storage device and numerically showing the assembling quality of the focus function of related components.

The other objective of the present invention is to provide an optical storage device that can perform a self test on the assembling quality for the focus function of the related components.

To achieve the foregoing objectives, the present invention provides a method of testing the assembling quality of an optical storage device, which comprises the steps of: (A) computing a traveling distance along the focus direction of a lens of an optical storage device and the first traveling time T1 for moving the lens from its lower limit position to its higher limit position; (B) Driving the optical pickup head of the optical storage device to emit a laser beam onto the inner track position of the optical disk and moving the lens from the lower limit position towards the higher limit position and starting to compute a second traveling time T2 obtained when a focus signal occurs; (C) Driving the optical pickup head of the optical storage device to emit a laser beam onto the outer track position and moving the lens from the lower limit position to the higher limit, and starting to compute a third traveling time T3 obtained when a focus signal occurs; and (D) Using an assembling quality formula based on the first traveling time, the second traveling time and the third traveling time to calculate the assembling quality of an optical storage device.

Further to achieve the foregoing objective, the present invention also provides an optical storage device for self testing the assembling quality of the optical storage device by coding a program to test the assembling quality of the optical storage device according to the method of the present invention, and such program codes are installed in the optical storage device in the form of a firmware.

### BRIEF DESCRIPTION OF THE DRAWINGS

The above objects and advantages of the present invention will become more apparent with reference to the appended drawings wherein:

FIG. 1 is a flow chart of the method according to the present invention;

FIG. 2 is a view of the hardware structure for the method adopted in the present invention;

FIG. 3 is an S-curve of the present invention;

FIG. 4 is a flow chart of the method for testing the deviation of the spindle motor according to the present invention; and

FIG. 5 is a flow chart of the method of testing the mechanical resonance deviation for different speeds according to the present invention.

### DETAILED DESCRIPTION OF THE INVENTION

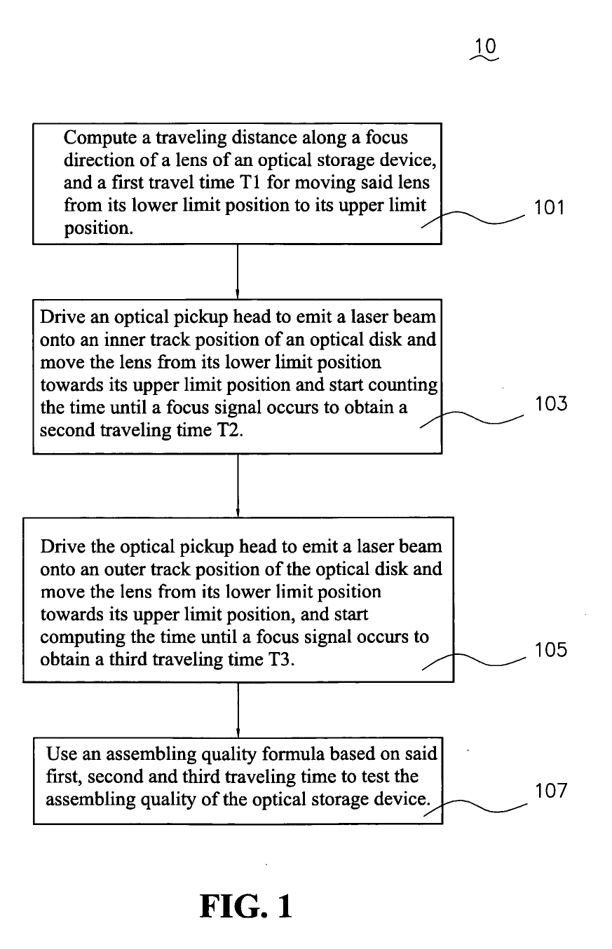

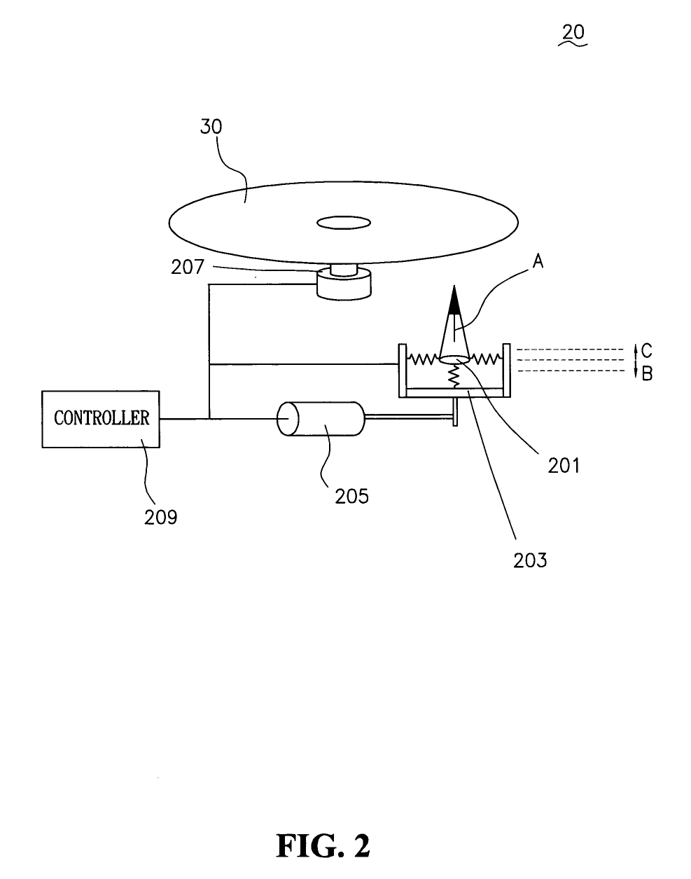

FIG. 1 shows the flow chart of the method of the present invention and FIG. 2 shows the view of the hardware structure according to the method of the present invention and the method 10 for testing the assembling quality of the optical storage device according to the present invention, which comprises Steps 101, 103 and 105 as described below. Step 101 computes the traveling distance along the focus direction A on the lens 201 of an optical storage device 20 and the first traveling time T1 for moving the lens 201 from its lower limit position B to its upper limit position C. The ideal position of an assembled lens 201 is at the position for focusing the lens 201 without moving the lens 201 upward or downward, and the lens can move along the focus direction A preferably 0.7 mm downward or 0.7 mm upward from the ideal position by an actuator. Therefore, the lens 201 can move freely from 0 mm to 1.4 mm. However, after the optical storage device 20 is assembled, the lens 201 cannot be installed to the ideal position due to the tolerance of components and poor assembling quality. In Step 101, the lens 201 is placed at the lower limit position B of the traveling route along the focus direction A and then moved towards the upper limit position C while starting to count the time. When the lens 201 is moved to the upper limit position C, it immediately stops moving and also stops counting the time which is the time required for the whole journey of the lens 201 and is defined as the first traveling time T1 in the invention.

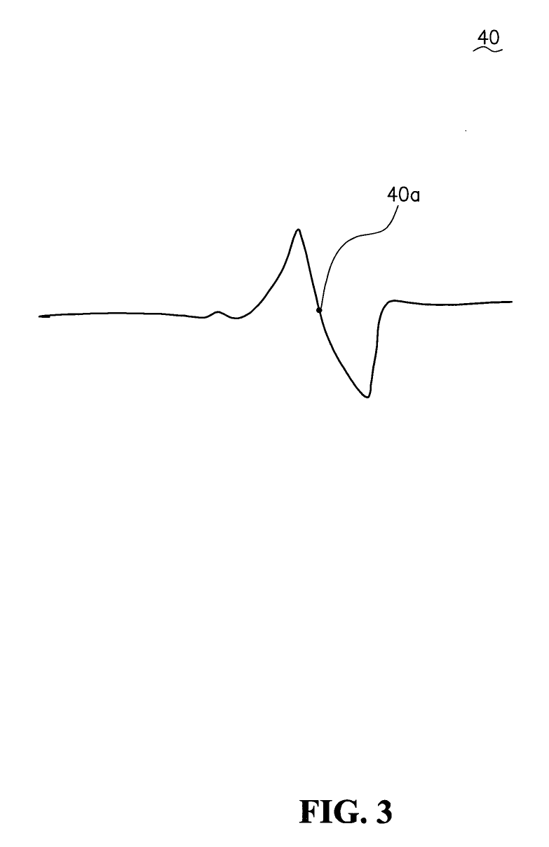

Step 103 drives the optical pickup head 203 of the optical storage device 20 to emit a laser beam onto the inner track position of an optical disk 30 and moves the lens 201 from the lower limit position B to the upper limit position C, while starting to compute a second traveling time T2 obtained when a focus signal occurs. In Step 103, a sled motor 205 is used to move the optical pickup head 203 and the lens 201 to the inner track position of the optical disk 30 and place the lens 201 at the lower limit position B of the traveling route along the focus direction A and moves towards the upper limit position C while starting to count the time. Please refer to FIG. 3 for the S-curve of the present invention. In FIG. 3, if a focus signal 40a shows up in an S-curve 40, it is the signal indicating that the lens 201 has focused the laser beam onto the recording layer of the optical disk 30. By then, the lens 201 is moved while detecting the focus signal. If a focus signal shows up, the lens 201 will immediately stop moving and the counting of time will be stopped concurrently. The time counted by that time is defined as the second traveling time T2 in the invention.

Step 105 drives the optical pickup head 203 of the optical storage device 20 to emit a laser beam onto the outer track position of the optical disk 30 and the lens 201 moves from the lower limit position B towards the upper limit position C, and starts to compute a third traveling time T3 obtained when a focus signal occurs. In Step 105, a sled motor 205 is used to move the optical pickup head 203 and the lens 201 to the outer track position of the optical disk 30 and place the lens 201 at the lower limit position B of the traveling route along the focus direction A and moves towards the upper limit position C while starting to count the time. If a focus signal 40a shows up in an S-curve 40, the lens 201 by then is moved while detecting the focus signal. If a focus signal shows up, the lens 201 will immediately stop moving and the counting of time will be stopped at the same time. The time counted by then is defined as the third traveling time T3 in the invention.

The technical characteristics of the second traveling time T2 and the third traveling time T3 obtained in Step 103 and Step 105 respectively represent the inner track position and the outer track position of the optical disk 30, where the lens 201 resides at a certain distance from 0 mm to 1.4 mm and forms a focus signal position at such distance. For example, the lens 201 of an ideal optical storage device 20 forms a focus signal position at a distance of 0.7 mm above the lower limit B position from the inner and outer track positions respectively. In other words, the lens 201 resides precisely at the ideal position and requires no further movement to form the focus signal position.

Step 107 uses an assembling quality formula based on the first traveling time T1, the second traveling time T2 and the third traveling time T3 to test the assembling quality of the optical storage device 20. In Step 107, the method 10 of the present invention can use the planar deviation (which is equal to T2−T3) of a guide bar as a formula for calculating the assembling quality to physically test the planar deviation of the guide bar. In general, an acceptable planar deviation of the guide bar preferably falls within an error range of 0.2 mm. In Step 107, the method 10 of the present invention can use the deviation between the ideal focus position and the actual focus position (which is equal to T2−(T1/2)) as a formula for calculating the assembling quality to physically test the deviation between the ideal focus position of the lens 201 and the actual focus position, which is caused by the installation of components. In general, the acceptable deviation preferably falls within an error range of 0.07 mm.

When the testing method 10 in accordance with the invention carries out the process from Step 101 to Step 107, the spindle motor 207 of the optical storage device 20 is stopped from rotating and lets the optical storage device 20 process in a static state.

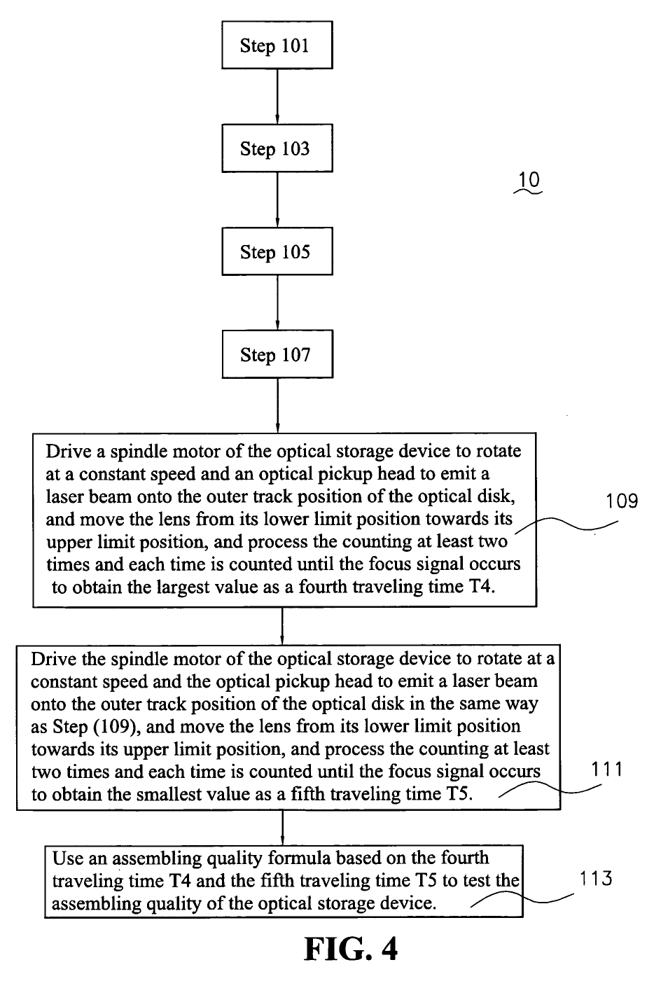

Further, the testing method 10 in accordance with the invention further comprises Steps 109, 111 and 113. Please refer to FIG. 4 for the flow chart of the method for testing the deviation of the spindle motor according to the present invention.

Step 109 drives a spindle motor 207 of the optical storage device 20 to rotate at a constant speed and an optical pickup head 203 emits a laser beam onto the outer track position of the optical disk 30, and moves the lens 201 from the lower limit position B towards the upper limit position C, and processes at least two counts to make the test more accurate. It is preferable to be processed four times or more, and a measured value is taken for each time when a focus signal has occurred in order to obtain the largest value among these measured values as the fourth traveling time T4. Similar to Step 109, Step 111 drives the spindle motor 207 of the optical storage device 20 rotates at a constant speed and an optical pickup head 203 emits a laser beam onto the outer track position of the optical disk 30, and moves the lens 201 from the lower limit position B towards the upper limit position C, and processes at least two counts to make the test more accurate. It is preferable to be processed four times or more, and a measured value is taken for each time when a focus signal has occurred in order to obtain the largest value among these measured values as the fifth traveling time T5.

Step 113 uses a formula based on the fourth traveling time T4 and the fifth traveling time T5 to test the assembling quality of the optical storage device 20.

The technical characteristics of the fourth traveling time T4 and the fifth traveling time T5 respectively obtained from Step 109 and Step 111 reside on the optical disk 30 being carried by the spindle motor 207 of and rotated at a constant speed. By then, a lens 201 is disposed at a certain distance from 0 mm to 1.4 mm from the outer track position of the optical disk 30, and a focus signal position is formed at the position from such distance. Since the optical disk 30 is processed in a dynamic state, therefore it is necessary to perform such process for several times to obtain a more accurate test, and eliminate the maximum and minimum values to obtain the fourth traveling time T4 and the fifth traveling time T5.

In Step 113, the method 10 of the invention uses a formula based on the planar deviation of the spindle motor 207 (which is equal to T4−T5) to test the assembling quality of the optical storage device 20. Since the surface of the optical disk 30 carried by the spindle motor 207 is not even, therefore it will not be positioned at an ideal horizontal surface and cause the carried optical disk 30 to tilt. In general, the deviation from the acceptable levelness of the spindle motor 207 preferably falls in the range of 0.10472 mm of the focus position of the lens 201 from the inner and outer tracks of the optical disk 30.

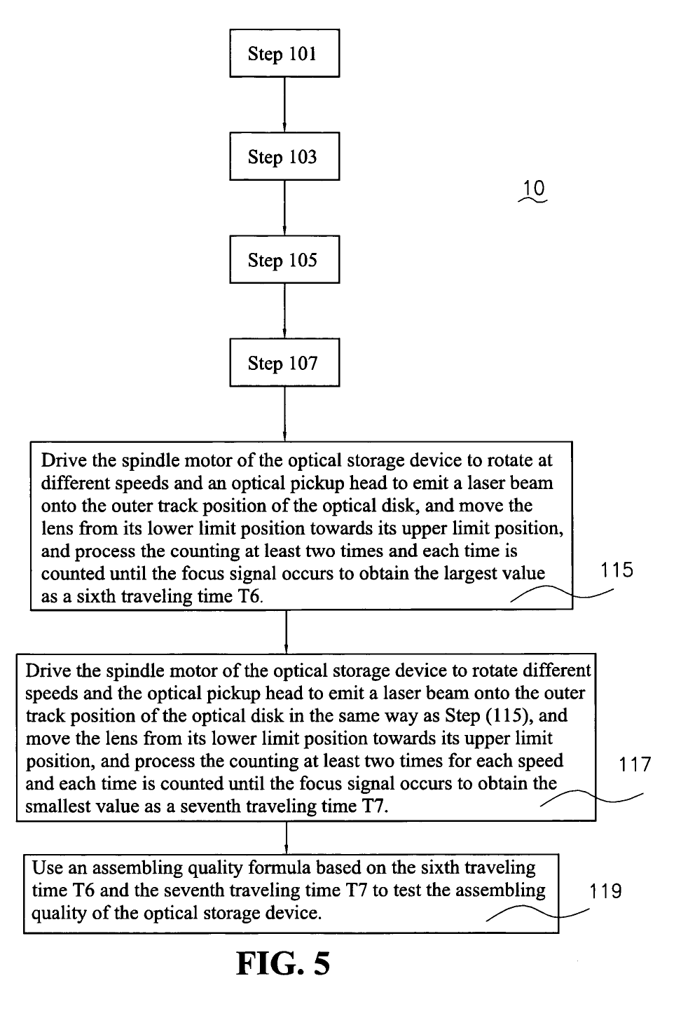

Further, the testing method 10 of the invention further comprises Step 115, Step 117 and Step 119. Please refer to FIG. 5 for the flow chart of the method for testing the mechanical resonance deviation of different speeds according to the present invention.

Step 115 drives a spindle motor 207 of the optical storage device 20 to rotate at different speeds and an optical pickup head 203 emits a laser beam onto the outer track position of the optical disk 30, and moves the lens 201 from the lower limit position B towards the upper limit position C, and processes at least two counts at each speed in order to make the test more accurate. It is preferable to be processed four times or more, and a measured value is taken by counting the time until a focus signal has occurred each time in order to obtain the largest value among these measured values as the sixth traveling time T6.

Similar to Step 115, Step 117 drives the spindle motor 207 of the optical storage device 20 rotates at different speeds and an optical pickup head 203 emits a laser beam onto the outer track position of the optical disk 30, and moves the lens 201 from the lower limit position B towards the upper limit position C, and processes at least two counts for each speed in order to make the test more accurate. It is preferable to be processed four times or more, and a measured value is taken by counting the time until a focus signal has occurred each time in order to obtain the smallest value among these measured values as the seventh traveling time T7.

Step 119 uses a formula based on the sixth traveling time T6 and the seventh traveling time T7 to test the assembling quality of the optical storage device 20.

The technical characteristics of the sixth traveling time T6 and the seventh traveling time T7 respectively obtained from Step 115 and Step 117 reside on the optical disk 30 being carried by the spindle motor 207 of and rotated at different speeds. By then, a lens 201 is disposed at a certain distance from 0 mm to 1.4 mm from the outer track position of the optical disk 30, and a focus signal position is formed at the position from such distance. Since the optical disk 30 is processed in a dynamic state, therefore it is necessary to perform such process several times for each speed to obtain a more accurate test, and eliminate the maximum and minimum values to obtain the sixth traveling time T6 and the seventh traveling time T7.

In Step 119, the method 10 of the invention uses a formula based on the mechanical resonance deviation of the spindle motor (which is equal to T6−T7−Planar levelness deviation of the spindle motor) at different speeds as Step 119 for testing the assembling quality of the optical storage device 20 and the mechanical resonance deviation at different speeds.

The testing method 10 of the invention could adopt program codes for its implementation. In other words, a firmware is installed into the optical storage device 20 and a controller 209 runs the program on the firmware.

The testing method 10 of the invention further comprises a driver program of the optical storage device 20 for displaying the measured values on a small window screen on a computer display device, so that the quality control personnel can easily know about the assembling quality of the optical storage devices 20 before shipping them out from the factory as well as the good quality policy. In the meanwhile, the present invention also provides users with a convenient way to learn about the good operating functions of the optical storage device 20 after it has been used for a while.

In general, the optical storage device 20 has restricted the optical storage device 20 in the range of 1.4 mm within the lower limit position B and the upper limit position C. Therefore, the formula Distance=Speed×Time and the parameters of distance 1.4 mm and the first traveling time T1 can be used to compute the moving speed parameter of the lens 201. By multiplying the moving speed parameter of the lens 201 with each time deviation, we can obtain the deviated distance in unit length of the planar deviation of the guide bar, the deviation between the ideal focus position and the actual focus position, the spindle motor planar levelness deviation and the mechanical resonance deviation. Taking each deviation into account, we can know about the focus position of the lens 201 at various different conditions and determine whether or not the lens 201 has approached 0.7 mm upward or 0.7 mm downward. Thus, we can know whether or not there is a chance for the lens 201 to go beyond the 0.7 mm limit upward or downward, which will cause a slow focus operation and deteriorate the performance for reading and duplicating optical disks.

The optical storage device 20 of the invention could be an optical disk drive and the optical disk drive could be a CD drive, a DVD drive, or a rewritable optical drive, etc.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for testing assembling quality of optical storage devices, comprising the steps of:
(A) computing a traveling distance along a focus direction of a lens of an optical storage device, and a first travel time T1 for moving said lens from its lower limit position to its upper limit position;
(B) driving an optical pickup head to emit a laser beam onto an inner track position of an optical disk and moving said lens from its lower limit position towards its upper limit position and starting to count the time until a focus signal occurs to obtain a second traveling time T2;
(C) driving said optical pickup head to emit a laser beam onto an outer track position of said optical disk and moving said lens from its lower limit position towards its upper limit position, and starting to compute the time until a focus signal occurs to obtain a third traveling time T3; and
(D) using an assembling quality formula based on said first, second and third traveling time to test the assembling quality of said optical storage device.

2. The method for testing the assembling quality of optical storage devices of claim 1, wherein said assembling quality formula of Step (D) refers to planar deviation of a guide bar=T2−T3.

3. The method for testing assembling quality of the optical storage devices of claim 1, wherein said assembling quality formula of Step (D) refers to deviation between the ideal focus position and actual position=T2−(T1/2).

4. The method for testing assembling quality of optical storage devices of claim 1, wherein said Steps (A) to (D) are preformed in the state when a spindle motor of said optical storage device stops rotating.

5. The method for testing assembling quality of optical storage devices of claim 1 further comprises the steps of:
(E) driving a spindle motor of said optical storage device to rotate at a constant speed and an optical pickup head to emit a laser beam onto the outer track position of said optical disk, and moving said lens from said lower limit position towards said upper limit position, and processing the counting at least two times and each time is counted until said focus signal occurs to obtain the largest value as a fourth traveling time T4;
(F) driving said spindle motor of said optical storage device to rotate at a constant speed and said optical pickup head to emit a laser beam onto the outer track position of said optical disk in the same way as Step (E), and moving said lens from its lower limit position towards its upper limit position, and processing the counting at least two times and each time is counted until said focus signal occurs to obtain the smallest value as a fifth traveling time T5;
(G) using an assembling quality formula based on the fourth traveling time T4 and the fifth traveling time T5 to test the assembling quality of said optical storage device.

6. The method for testing assembling quality of optical storage devices of claim 5, wherein said assembling quality formula of Step (G) refers to planar levelness deviation of said spindle motor=T4−T5.

7. The method for testing the assembling quality of optical storage devices of claim 5 further comprises the steps of:
(H) driving said spindle motor of said optical storage device to rotate at different speeds and an optical pickup head to emit a laser beam onto the outer track position of said optical disk, and moving said lens from said lower limit position towards said upper limit position, and processing the counting at least two times and each time is counted until said focus signal occurs to obtain the largest value as a sixth traveling time T6;
(I) driving said spindle motor of said optical storage device to rotate different speeds and said optical pickup head to emit a laser beam onto the outer track position of said optical disk in the same way as Step (H), and moving said lens from its lower limit position towards its upper limit position, and processing the counting at least two times for each speed and each time is counted until said focus signal occurs to obtain the smallest value as a seventh traveling time T7;
(J) using an assembling quality formula based on said sixth traveling time T6 and said seventh traveling time T7 to test the assembling quality of said optical storage device.

8. The method for testing the assembling quality of optical storage devices of claim 7, wherein said assembling quality formula of Step (K) refers to mechanical resonance deviation at each of the different speeds=T6−T7−(T4−T5).

9. The method for testing assembling quality of optical storage devices of claim 1, wherein said optical storage device is an optical disk drive.

10. The method for testing the assembling quality of optical storage devices of claim 1, wherein said testing method is implemented by compiling program codes.

11. The method for testing the assembling quality of optical storage devices of claim 1, wherein said program codes are executed by said optical storage device.

12. An optical storage device capable of self-testing assembling quality, comprising:
an optical pickup head, for emitting a laser beam onto an optical disk;
a lens, for focusing said laser beam onto said optical disk;
a controller;
a program code, being executed by said controller of said optical storage device, such that said optical storage device processes the steps of:
(A) computing a traveling distance along a focus direction of a lens of an optical storage device, and a first travel time T1 for moving said lens from its lower limit position to its upper limit position;
(B) driving an optical pickup head to emit a laser beam onto an inner track position of an optical disk and moving said lens from its lower limit position towards its upper limit position and starting to count the time until a focus signal occurs to obtain a second traveling time T2;
(C) driving said optical pickup head to emit a laser beam onto an outer track position of said optical disk and moving said lens from its lower limit position towards its upper limit position, and starting to compute the time until a focus signal occurs to obtain a third traveling time T3; and
(D) using an assembling quality formula based on said first, second and third traveling time to test the assembling quality of said optical storage device.

13. The optical storage device of claim 12, wherein said assembling quality formula of Step (D) refers to the planar deviation of a guide bar=T2−T3.

14. The optical storage device of claim 12, wherein said assembling quality formula of Step (D) refers to the deviation between the ideal focus position and the actual position=T2−(T1/2).

15. The optical storage device of claim 12, wherein said Steps (A) to (D) are preformed in the state when a spindle motor of said optical storage device stops rotating.

16. The optical storage device of claim 12 further comprises a program code being executed by said optical storage device for:
(E) driving a spindle motor of said optical storage device to rotate at a constant speed and an optical pickup head to emit a laser beam onto the outer track position of said optical disk, and moving said lens from said lower limit position towards said upper limit position, and processing the count at least two times with each time is counted until said focus signal occurs to obtain the largest value as a fourth traveling time T4;
(F) driving said spindle motor of said optical storage device to rotate at a constant speed and said optical pickup head to emit a laser beam onto the outer track position of said optical disk in the same way as Step (E), and moving said lens from its lower limit position towards its upper limit position, and processing the counting for at least two times and each time is counted until said focus signal occurs to obtain the smallest value as a fifth traveling time T5;
(G) using an assembling quality formula based on the fourth traveling time T4 and the fifth traveling time T5 to test the assembling quality of said optical storage device.

17. The optical storage device of claim 16, wherein said assembling quality formula of Step (G) refers to planar deviation of a guide bar=T4−T5.

18. The optical storage device of claim 16 further comprising a program code being executed by said optical storage device for:
(H) driving said spindle motor of said optical storage device to rotate at different speeds and an optical pickup head to emit a laser beam onto the outer track position of said optical disk, and moving said lens from said lower limit position towards said upper limit position, and processing the counting for at least two times and each time is counted until said focus signal occurs to obtain the largest value as a sixth traveling time T6;
(I) driving said spindle motor of said optical storage device to rotate different speeds and said optical pickup head to emit a laser beam onto the outer track position of said optical disk in the same way as Step (H), and moving said lens from its lower limit position towards its upper limit position, and processing the counting for at least two times for each speed and each time is counted until said focus signal occurs to obtain the smallest value as a seventh traveling time T7;
(J) using an assembling quality formula based on said sixth traveling time T6 and said seventh traveling time T7 to test the assembling quality of said optical storage device.

19. The optical storage device of claim 18, wherein said assembling quality formula of Step (K) refers to mechanical resonance deviation at each of different speeds=T6−T7−(T4−T5).

20. The optical storage device of claim 12, wherein said optical storage device is an optical disk drive.
